(19) United States
(12) Patent Application Publication
(10) Pub. No.: US 2005/0285723 A1
(43) Pub. Date: Dec. 29, 2005

(54) Global positioning system having instant notification of vehicle status function

(76) Inventors: Ying-Nan Chen, Kaohsiung Hsien (TW); Ching-Tai Fan, Kaohsiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/959,048

(22) Filed: Oct. 7, 2004

(30) Foreign Application Priority Data
Jun. 29, 2004 (TW) 093118920

(51) Int. Cl. B60R 25/10; G08B 1/08

(52) U.S. Cl. 340/426.15; 340/539.13

(57) ABSTRACT

A global positioning system (GPS) having instant notification of vehicle status function includes a GPS satellite signal-receiver module (11), a satellite signal-receiving antenna (12), a checking signal processing circuit (20) and a wireless communication module (30). The GPS satellite signal-receiver module (11) acquires an abnormal status of vehicle message from the checking signal processing circuit (20), and via the satellite signal-receiving antenna (12) receives vehicle position data. After processing, the wireless communication module (30) sends the data to a remote host (62) to provide the instant notification of vehicle status. Therefore, the GPS having instant notification of vehicle status function can effectively simplify a module of vehicle theft and security system circuits and components, so as to reduce cost.

### BACKGROUND OF THE INVENTION

1. Field of the Invention

The invention relates in general to a global positioning system (GPS), and more particularly to a GPS having instant notification of vehicle status function operating in coordination with a wireless communication system.

2. Description of the Related Art

Taiwan patent 474279 of “VEHICLE TELEPHONE DEVICE HAVING AUTOMOBILE SECURITY” disclosed a vehicle telephone device in communication with a driver's personal phone, wherein if the driver is away from the vehicle while it is broken into etc, the driver is able to remotely deactivate vital functions of the vehicle, thereby effectively disabling the vehicle. In view of the above mentioned invention patent, the invention mainly develops an automobile security system for an individual. Thus the owner of the vehicle is able to control several security functions by which vehicle theft is preventable. Taiwan Patent 562208 disclosed a similar invention to the previous cited patent in that a vehicle burglar alarm co-operates with a remote device, although this second patent defines in greater detail a variety of telecommunication devices, such as fax, email etc, by which the responsible person can be notified of the break in.

The above mentioned two invention patents provide similar security devices for vehicle owners to manage by themselves. Currently vehicle manufacturers and security firms also provide fairly good vehicle security services. That is, the vehicle manufacturers or the security firms can manage the vehicle security after a vehicle security device has been integrated with the wireless communication system, and thus the owner need not participate in the monitoring of the vehicle. Therefore, a better vehicle security service can be provided for the owners.

Taiwan patent 413366 of “VEHICLE COMMUNICATION SECURITY TRACING DEVICE” disclosed a microprocessor connected with a sensor, co-operating with a GPS and GSM (Global System for Mobile Communications) wireless communication host to achieve an object of instant fixed position tracing for a vehicle. A security objective can be achieved by the sensor transmitting signals to a management terminal via the GSM wireless communication host. Furthermore, three invention patents Taiwan 566382, Taiwan 566383, and Taiwan 573649 of “VEHICLE SECURITY DEVICE” reveal similar functions and components. However, Taiwan patent 566382 and Taiwan patent 566383 separately further define a wireless communication module for a specific communication status, while Taiwan 573649 patent further provides a defense device to respond accordingly to a command sent back by a management terminal. Therefore, the above mentioned three invention patents all make use of the wireless communication device to connect with a management host to send back information on a vehicle's status, so as to achieve vehicle security.

However, the previous disclosed invention patents all mainly require addition of the microprocessor as a principal control unit, and separately co-operate with the wireless communication module or the GPS module, so as to achieve vehicle security. No matter whether the wireless communication module or the GPS module is used, both require further inclusion of a microprocessor to process different frequency wireless signals and then output the signals to a main microprocessor of the security device. Alternatively, the main microprocessor of the security device inputs signals to the security device. Then the microprocessor processes the signals as wireless signals and transmits them to the management terminal. This design method is not inappropriate; nevertheless, the microprocessor unit price is very high. In addition, although integrating more modules can strengthen the vehicle's functions, the cost accordingly increases greatly to the extent that it is beyond affordability for most consumers. Therefore, the security device having wireless reporting functions requires further improvement and design to reduce vehicle wireless communication cost.

### SUMMARY OF THE INVENTION

In accordance with one aspect, the present invention provides a GPS having an instant notification of vehicle status reporting function achieved by a GPS satellite signal receiver module without requiring any additional microprocessor. Therefore, the present invention of the GPS having instant notification of vehicle status reporting function improves a conventional device fitted with a microprocessor, so as to significantly reduce costs while providing improved security function, thus enhancing the product's competitiveness.

The GPS having an instant notification of vehicle status function mainly includes a GPS satellite signal receiver module, a satellite signal-receiving antenna, a checking signal processing circuit, and a wireless communication module.

The GPS satellite signal-receiver module comprises a GPS satellite data acquisition program and a response measure to a vehicle status program. The satellite signal-receiving antenna connects with the GPS satellite signal-receiver module.

The checking signal processing circuit connects to the GPS satellite signal-receiver module for connecting with a sensor device in a vehicle to send a vehicle's status to the GPS satellite receiver module. Furthermore, the wireless communication module connects with the GPS satellite signal-receiver module, so as to set up a mutual connection of the GPS satellite signal-receiver module and a remote host.

The above mentioned GPS satellite signal-receiver module is used for receiving and processing GPS satellite signal data. The GPS satellite signal-receiver module also co-operates with the checking signal processing circuit to check the vehicle's status, and to send back the vehicle status and vehicle position data to the remote host by the wireless communication module.

Therefore, the present invention can fully utilize the GPS satellite signal-receiver module of the global positioning system (GPS) to integrate both checking and position data processing, so as to effectively reduce vehicle security device cost.

In accordance with another aspect, the present invention provides a global positioning system (GPS) easy to integrate with an external connecting security alarm system. If some vehicles have already been fitted with a security alarm, the present invention also provides an external emulation unit for a security alarm signal. After the external emulation unit for the security alarm signal connects with the security alarm in the vehicle, the external emulation unit for the security alarm signal emulates and stores different signal waveforms outputted while starting a security mode, canceling the security mode and triggering the security mode separately, so as to provide for the GPS satellite signal-receiver module to control and judge the external security alarm accordingly. Therefore, the present invention can provide a function for integrating with the security alarm.

In accordance with another aspect, the present invention provides a GPS having a spare power supply. Accordingly, the GPS satellite signal-receiver module connects with a voltage examiner unit for a storage battery and a spare battery and a circuit checking unit for a storage battery supply. When the storage battery disconnects with a power-supply circuit, a control signal is outputted to a power supply switch circuit. The power-supply switch circuit connects with a spare storage battery, a vehicle voltage converter of a storage battery and a working power supply terminal of a wireless communication module. Thus, the spare storage battery can immediately supply power to the wireless communication module, so that the wireless communication module can continue to return signals to a remote host. Therefore, the present invention can prevent unauthorized cutting off electricity from the storage battery, such as a thief trying to disarm an alarm system, whereby security functions cannot be tampered with.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 shows a circuit block diagram of a preferred embodiment of the present invention.

FIG. 2 shows a preferred embodiment of emulating outputted waveforms in different security modes of the present invention.

FIG. 3 illustrates a preferred embodiment of the present invention integrating an external security alarm and connecting to a remote host.

FIG. 4 A, B, C and D show a detailed circuit diagram of a preferred embodiment of the present invention.

FIG. 5 shows a function flow diagram of a preferred embodiment of the present invention.

FIG. 6 shows a circuit block diagram of a preferred embodiment of the present invention.

### DETAILED DESCRIPTION OF THE INVENTION

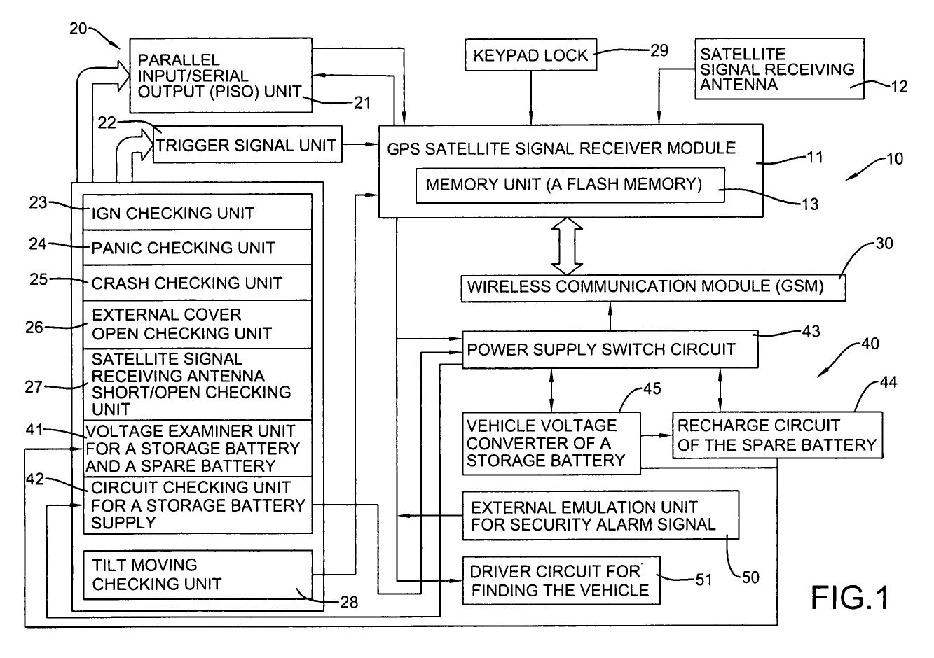

Referring to FIG. 1 firstly, a circuit block diagram of a preferred embodiment of the present invention of a global positioning system (GPS) 10 is shown. The GPS 10 mainly includes

a GPS satellite signal-receiver module 11, a satellite signal-receiving antenna 12, a checking signal processing circuit 20, and a wireless communication module 30.

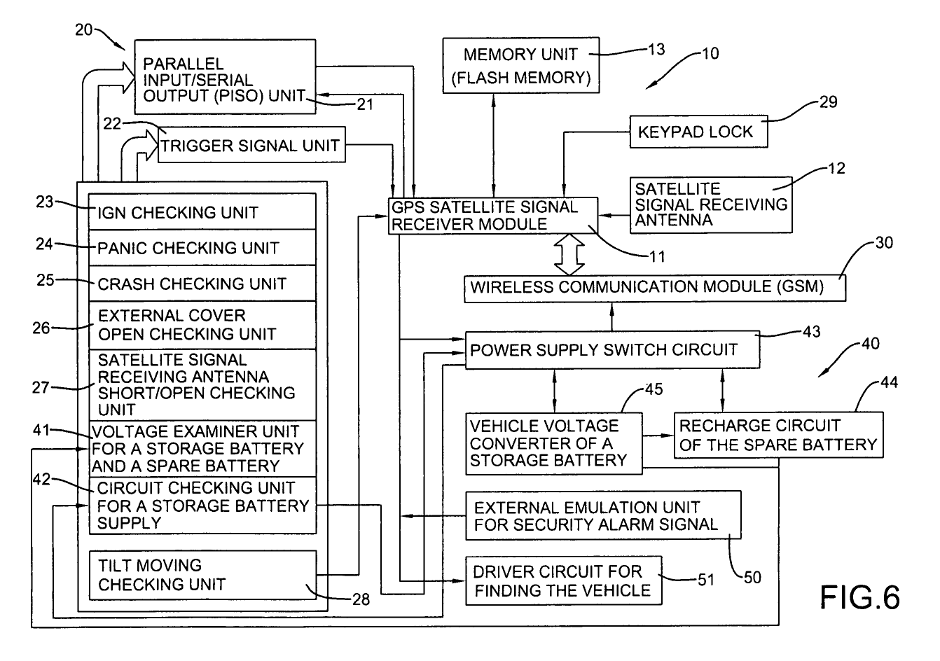

The GPS satellite signal-receiver module 11 comprises a GPS satellite data acquisition program and a response to vehicle status program wherein the response to vehicle status program writes to a memory unit 13 and the memory unit 13 is installed (e.g., embedded) in the GPS satellite signal-receiver module 11. The memory unit 13 also can be installed to the exterior of the GPS satellite signal-receiver module 11 in an electrically conductive manner as shown in FIG. 6, which is not limited in practice.

The satellite signal-receiving antenna 12 connects with the GPS satellite signal-receiver module 11. The checking signal processing circuit 20 connects to the GPS satellite signal-receiver module 11 to send vehicle status signals to the GPS satellite signal-receiver module 11. The wireless communication module 30 connects with the GPS satellite signal-receiver module 11, so as to set up a mutual connection of the GPS satellite signal-receiver module 11 and a remote host (not shown in the diagram). In this preferred embodiment, the wireless communication module 30 is a GSM (Global System for Mobile Communications) communication module.

The above mentioned checking signal processing circuit 20 mainly includes a plurality of checking units for installing in appropriate positions in the vehicle to examine if there is any abnormal vehicle status. If the abnormal vehicle status happens, a signal is outputted. The plurality of the checking units includes: an IGN checking unit 23, a panic checking unit 24, a crash checking unit 25, an external cover open checking unit 26, a satellite signal-receiving antenna short/open checking unit 27, a voltage examiner unit (41) and a circuit checking unit (42).

A parallel input/serial output (PISO) unit 21 with an input terminal of the PISO unit 21 connects to an output terminal of all of the checking units, and an output terminal of the PISO unit 21 connects to the GPS satellite signal-receiver module 11. A trigger signal unit 22 is configured in the GPS satellite signal-receiver module 11 to output a signal to notify the GPS satellite signal-receiver module 11 of the abnormal vehicle status, and the GPS satellite signal-receiver module 11 reads a signal of the parallel input/serial output (PISO) unit 21.

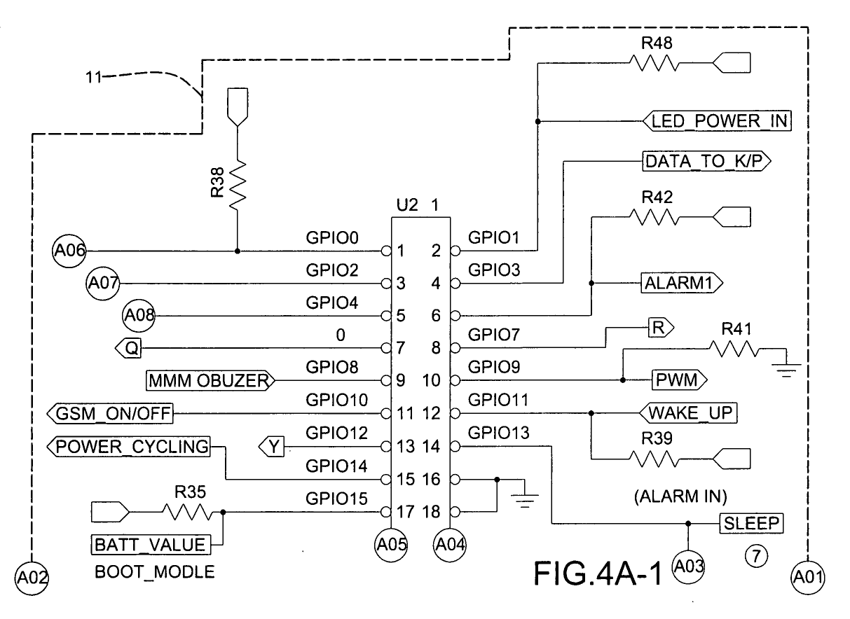

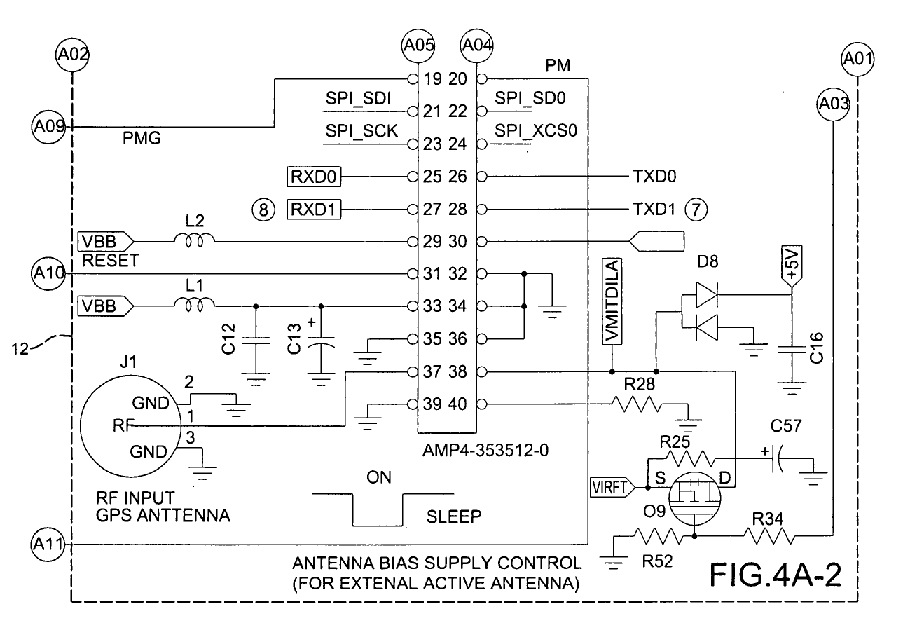

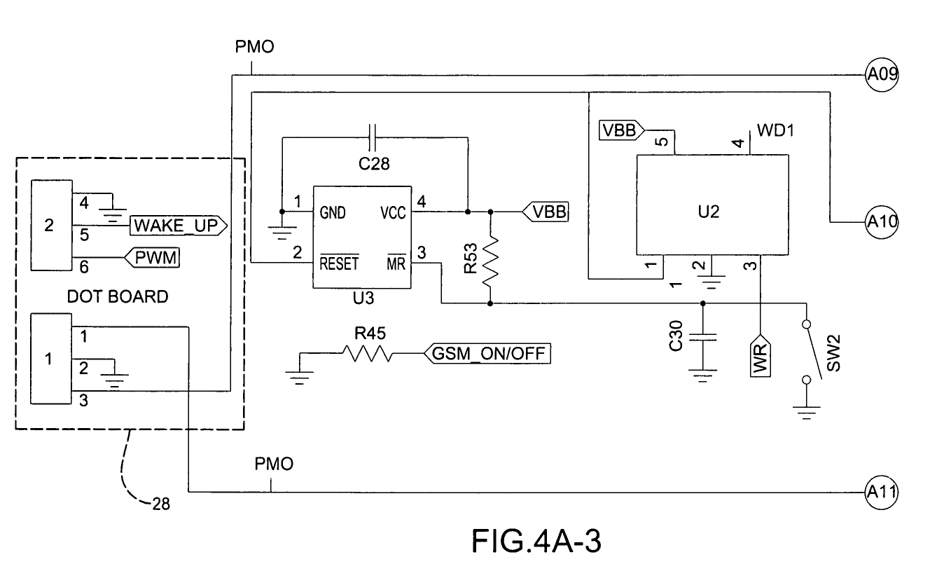

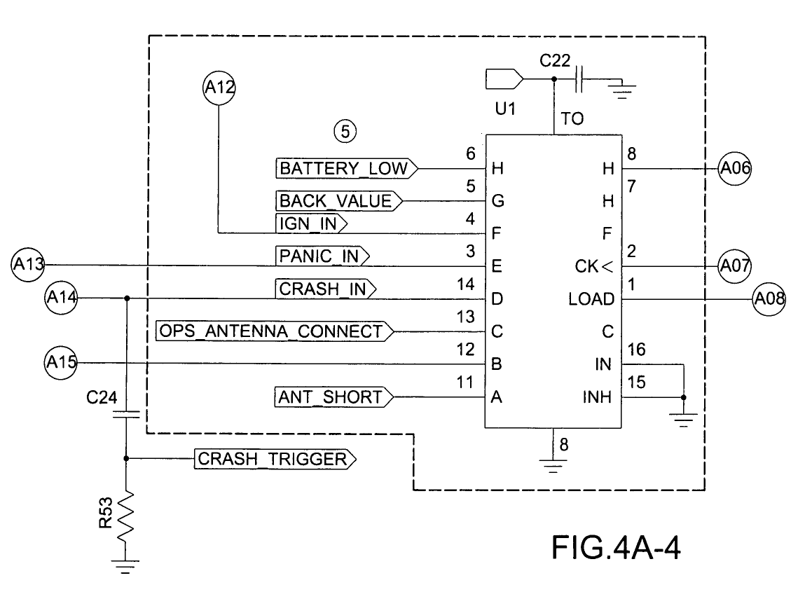

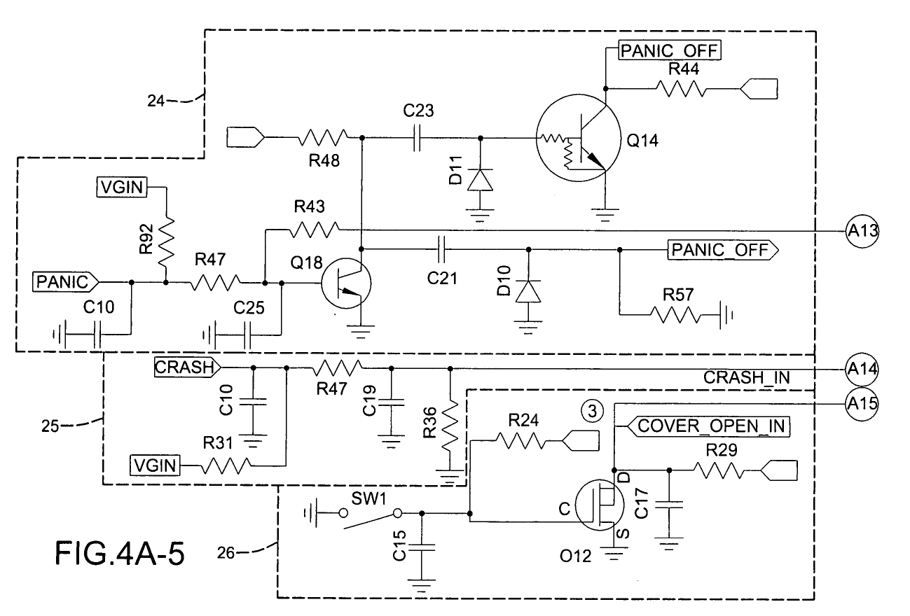

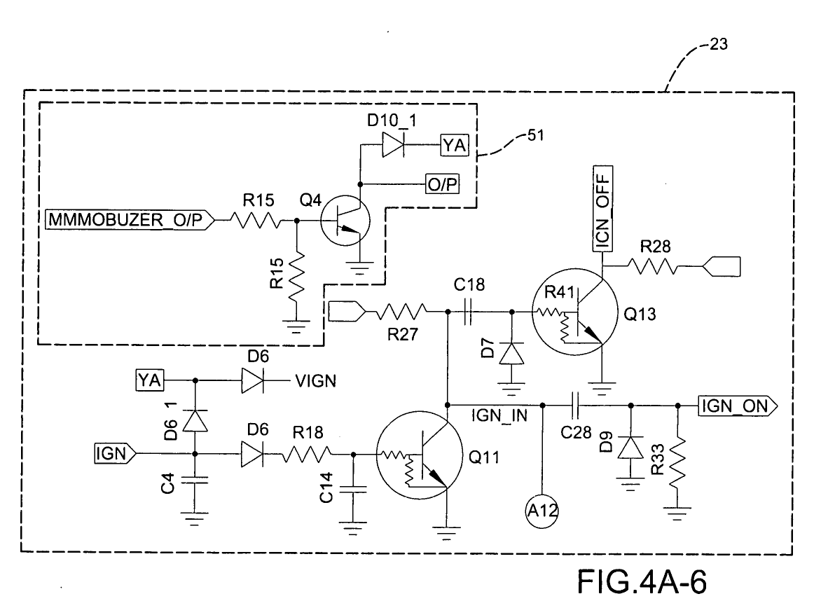

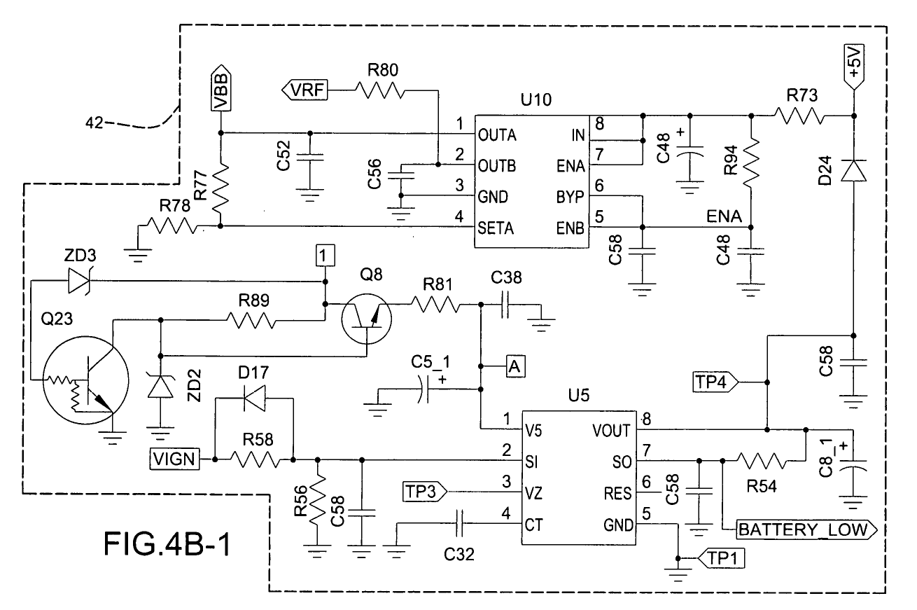

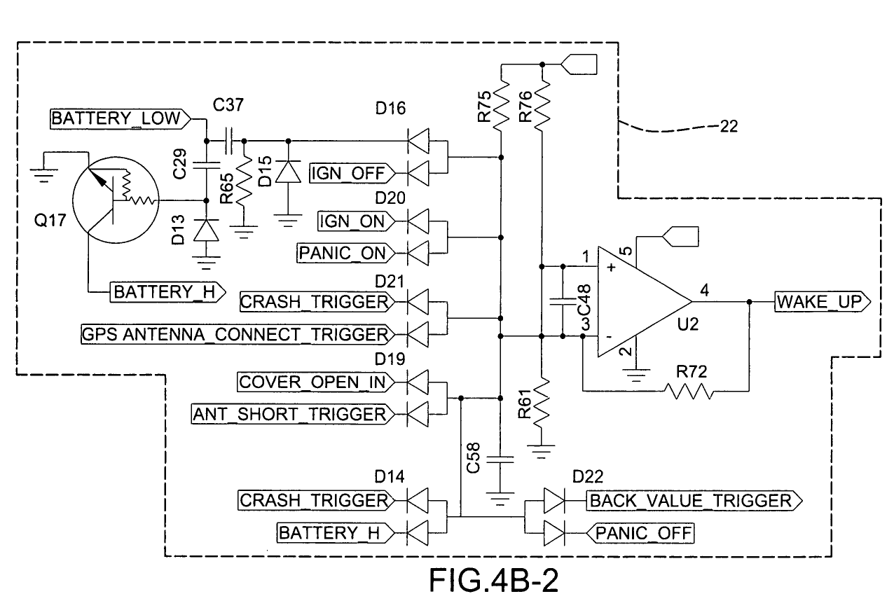

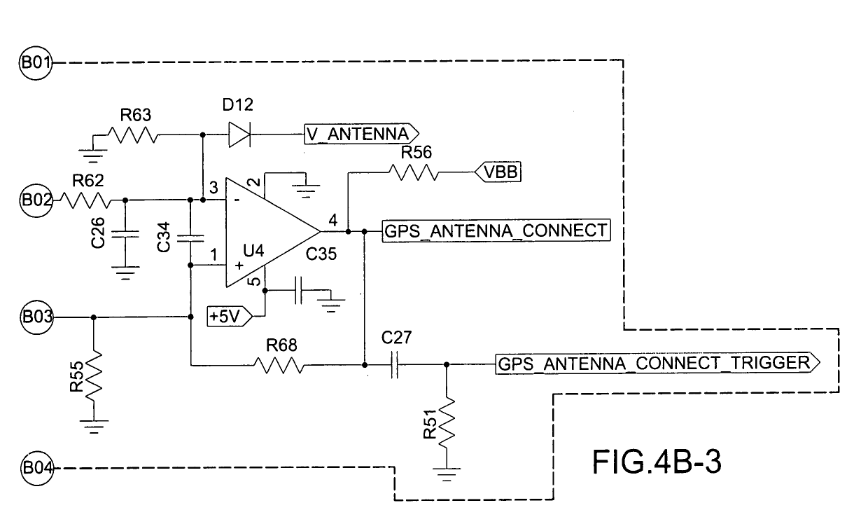

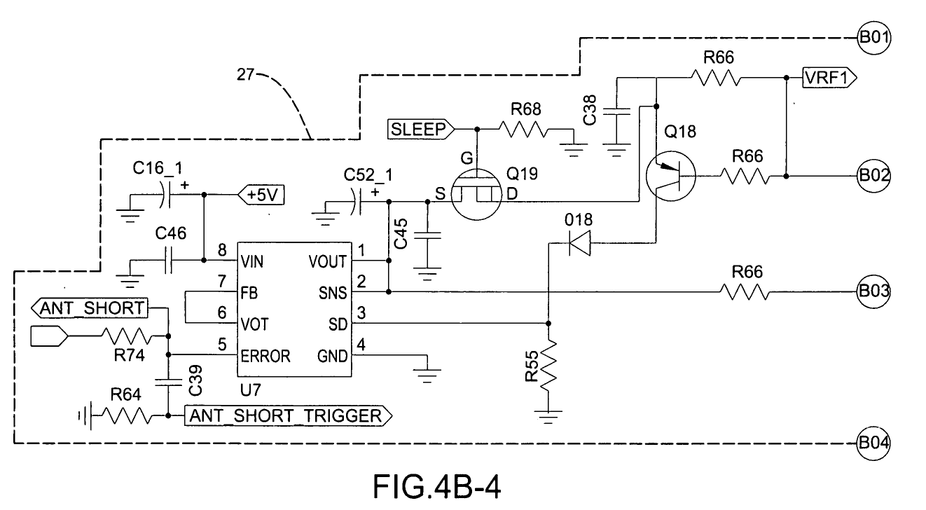

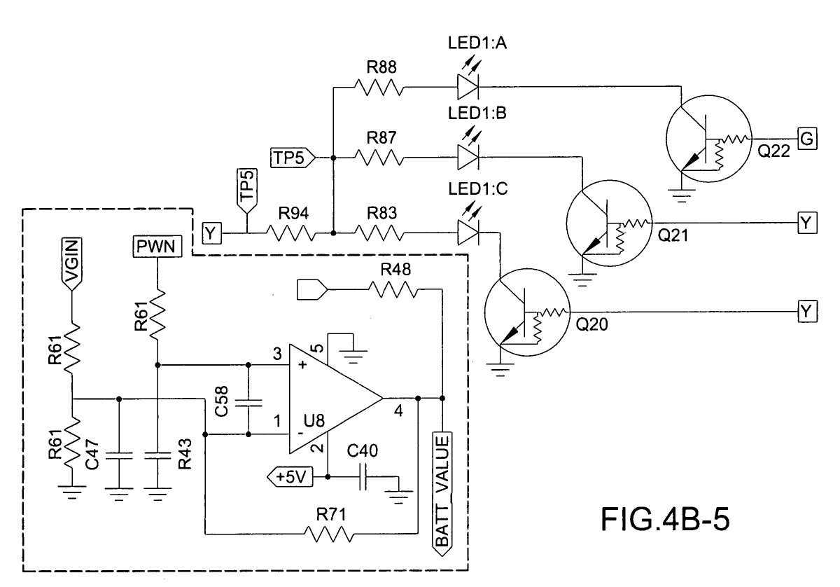

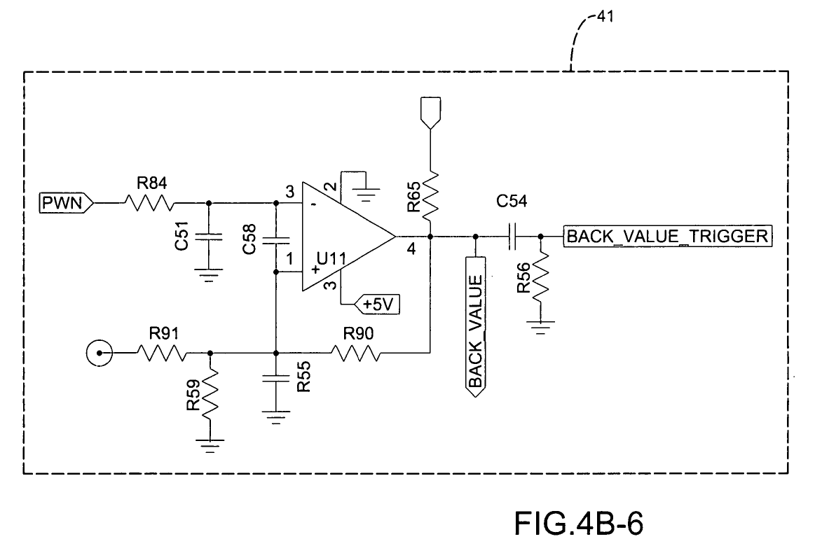

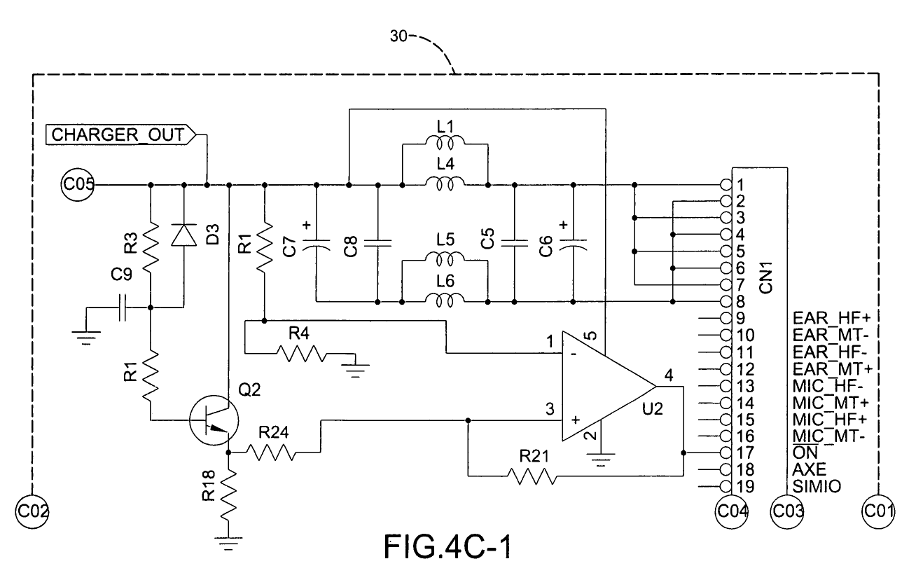

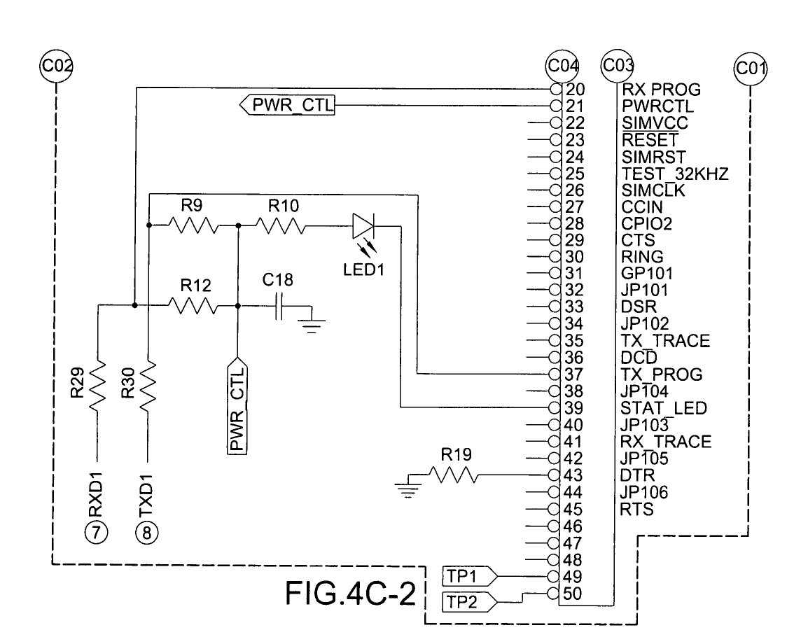

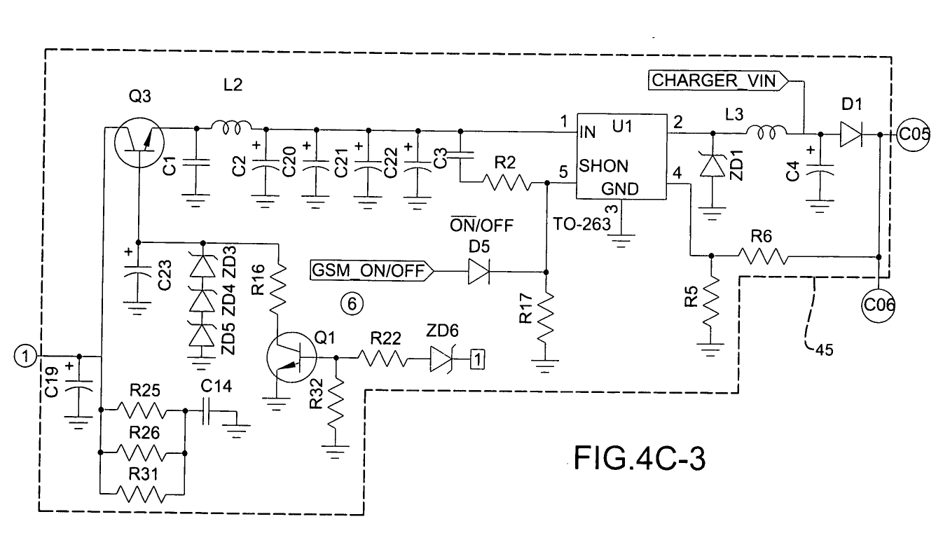

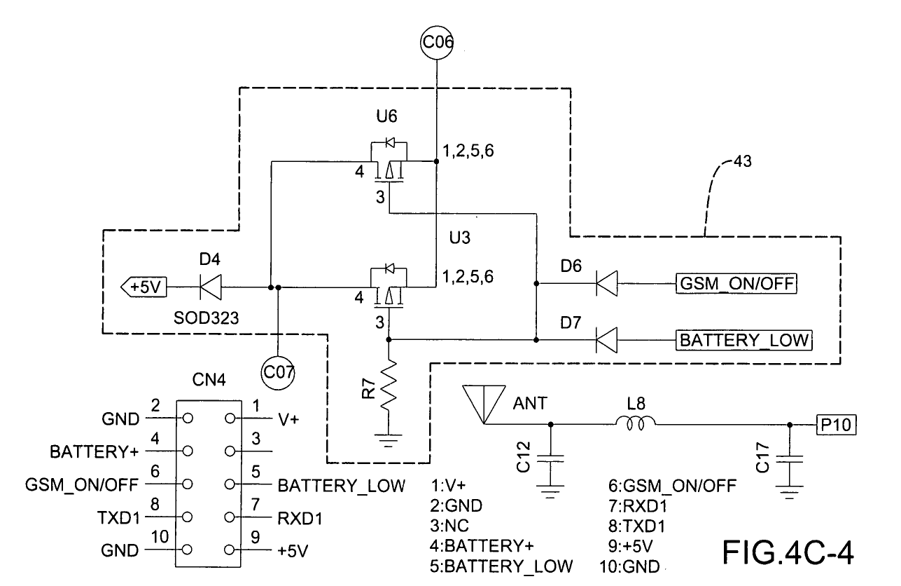

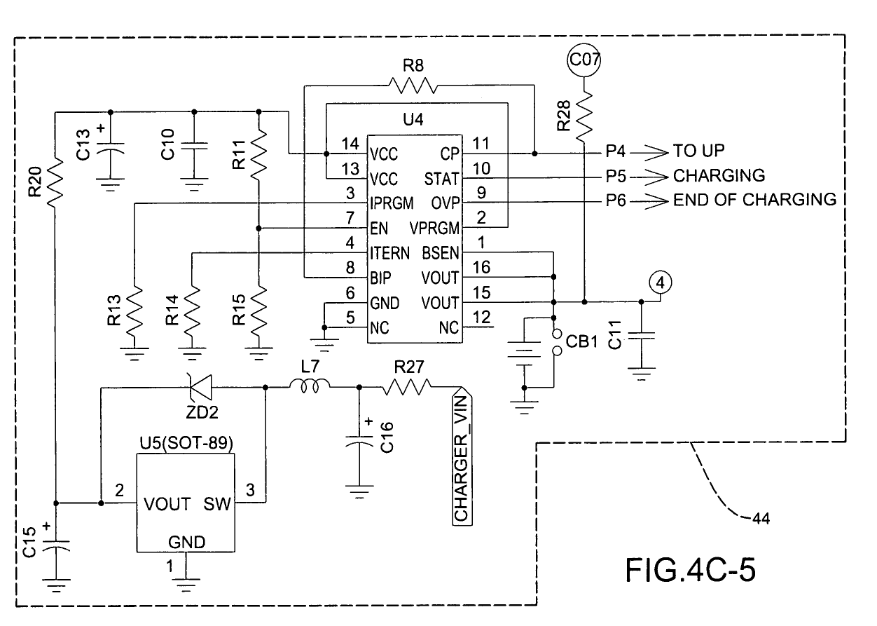

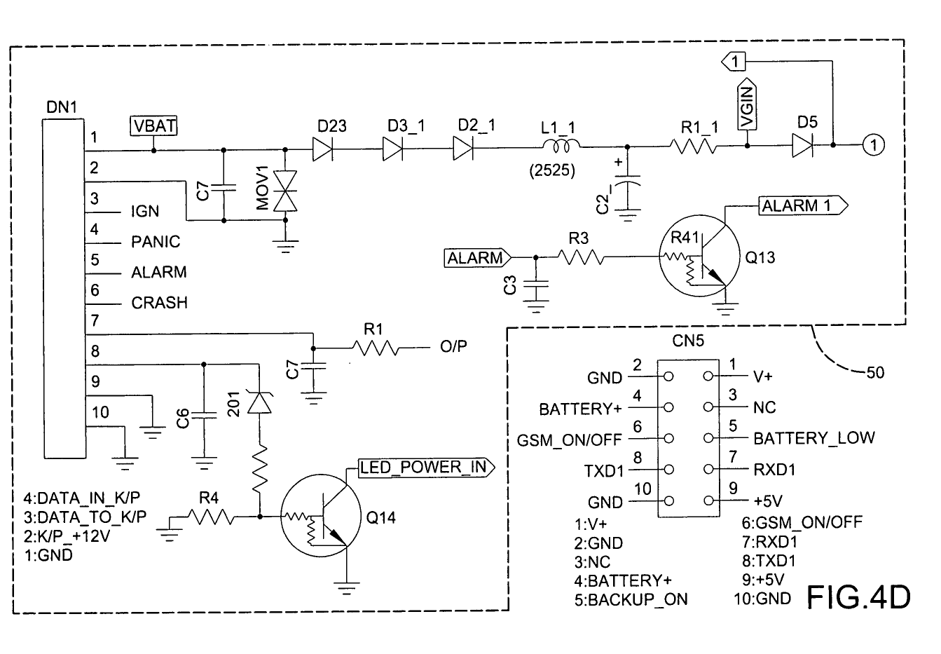

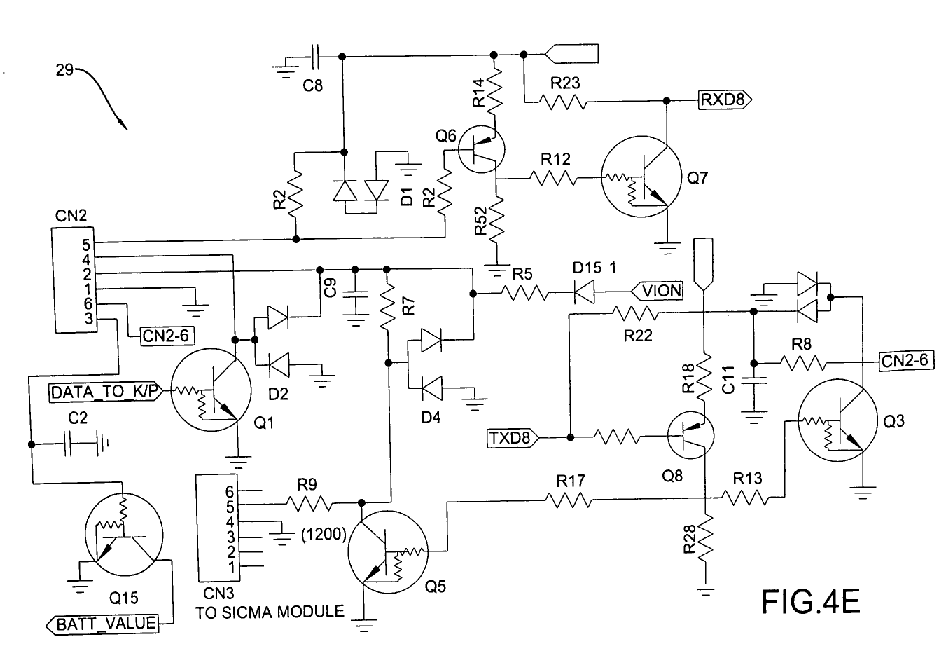

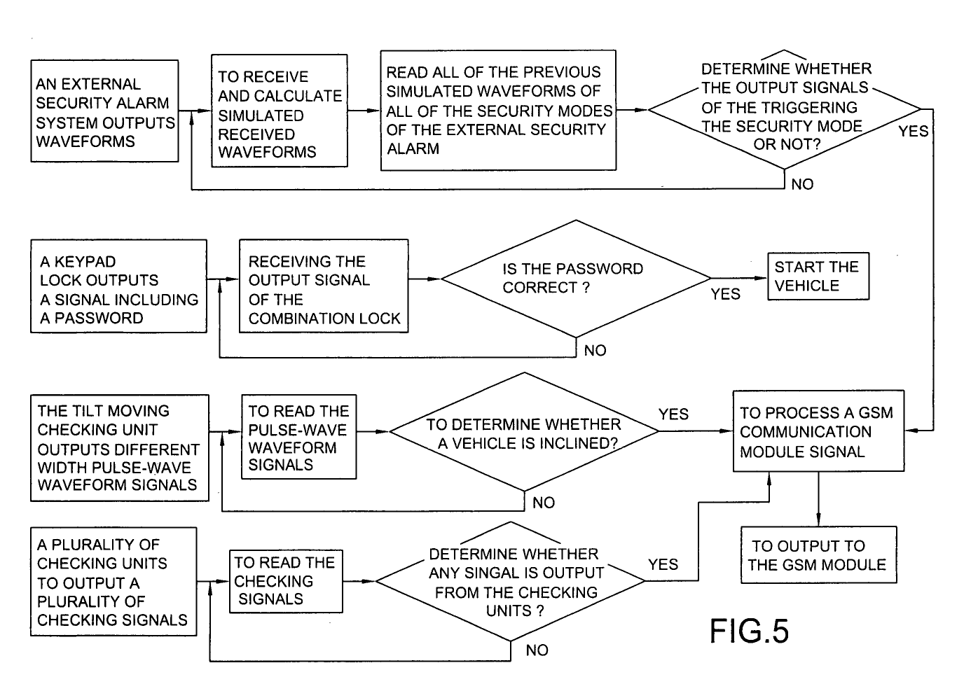

With reference to FIG. 4 and FIG. 5, when any of the above-mentioned checking units finds an abnormal status and outputs a checking signal, the trigger signal unit 22 outputs a notification signal to the GPS satellite signal-receiver module 11. Then the GPS satellite signal-receiver module 11 reads the signal of the parallel input/serial output (PISO) unit 21 to acquire the checking signal, and further together with position data of the GPS satellite signal-receiver module 11 to be returned to the remote host by the wireless communication module 30. In this way, the remote host can monitor the vehicle's status and the vehicle's position.

Furthermore, the above-mentioned checking signal processing circuit 20 further includes a tilt moving checking unit 28 to monitor whether the vehicle is tile or moving. Since the tilt moving checking unit 28 can output different checking signals of different pulse width modulation (PWM) signals depending on different angles of inclination, the GPS satellite signal-receiver module 11 can receive information of whether the vehicle is tilted or the angles of inclination by judging the waveform widths of the PWM signals. The checking signals together with the position data are then sent back to the remote host.

Moreover, the preferred embodiment of the present invention further includes a spare power supply circuit 40, comprising: a voltage examiner unit 41 for a storage battery and a spare battery, a circuit checking unit 42 for a storage battery supply, a power supply switch circuit 43, a recharge circuit of the spare battery 44, and a vehicle voltage converter 45 of a storage battery. The circuit checking unit 42 for the storage battery supply is used for examining whether a power supply circuit of the storage battery is disconnected. If the power supply circuit of the storage battery is disconnected, a checking signal is outputted to the power supply switch circuit 43. Since the power supply switch circuit 43 connects with a recharge circuit of the spare storage battery 44, a vehicle voltage converter 45 of a storage battery and a working power supply terminal of the above-disclosed circuits, as shown in FIG. 4C, the recharge circuit of the spare storage battery 44 can immediately supply power for the above-disclosed circuits by the power supply switch circuit 43, so as to provide continuous operation. Wherein the voltage examiner unit 41 for the storage battery and the spare battery and the circuit checking unit 42 for the storage battery supply connect to the GPS satellite signal-receiver module 11 with the parallel input/serial output (PISO) unit 21 and the trigger signal unit 22 separately. That is, when the GPS satellite signal-receiver module 11 examines and reads the output signals of the examiner unit 41 and the circuit checking unit 42, the signals are also returned to the remote host by the wireless communication module 30.

The above-mentioned memory unit 13 can use a flash memory.

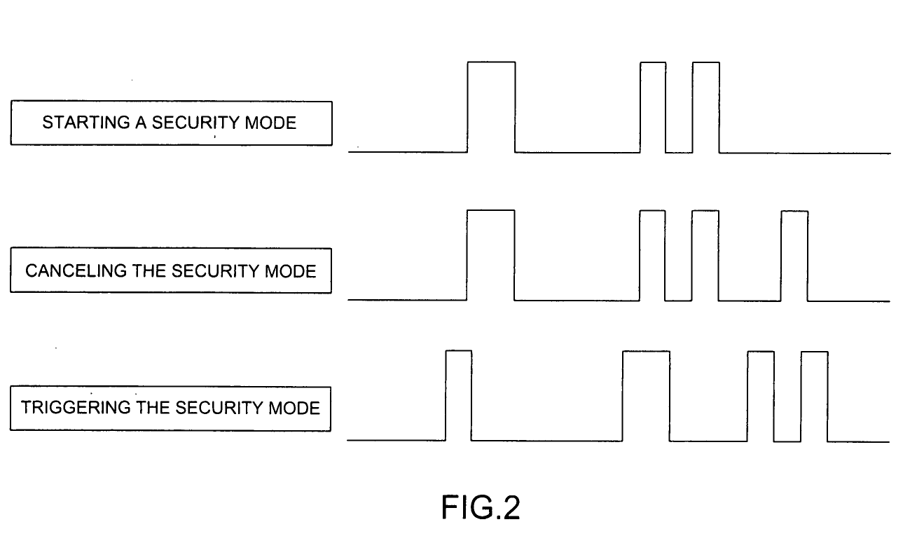

Referring to FIG. 1, FIG. 4A and FIG. 4D, the present invention includes in addition to the above-mentioned functions of response vehicle status, vehicle positions and spare power supply, the above-mentioned GPS satellite signal-receiver module 11 further includes an external emulation unit 50 for a security alarm signal for connecting to an external security alarm (not shown in the diagram) originally installed in the vehicle. The external emulation unit 50 for the security alarm signal records and emulates different signal waveforms outputted by the external security alarm while starting a security mode, canceling the security mode and triggering the security mode separately, so that the GPS satellite signal-receiver module 11 can control and judge the external security alarm accordingly. Therefore, the present invention can provide a function for integrating with the security alarm by the external emulation unit 50 for the security alarm signal without dismantling the original security alarm. With reference to FIG. 2, a preferred embodiment of an external emulation unit for a security alarm signal emulating outputted signal waveforms by a security alarm in different security modes of the present invention is shown. Most vehicle security alarms are of the above-mentioned three modes presently, and also output signals of pulse-wave waveforms for every mode. Different brands of security alarms would set different pulse-wave numbers and widths. Therefore, the GPS satellite signal-receiver module of the present invention can record specific actuation of the external emulation unit for the security alarm signal and integrate the original security alarm with the present invention.

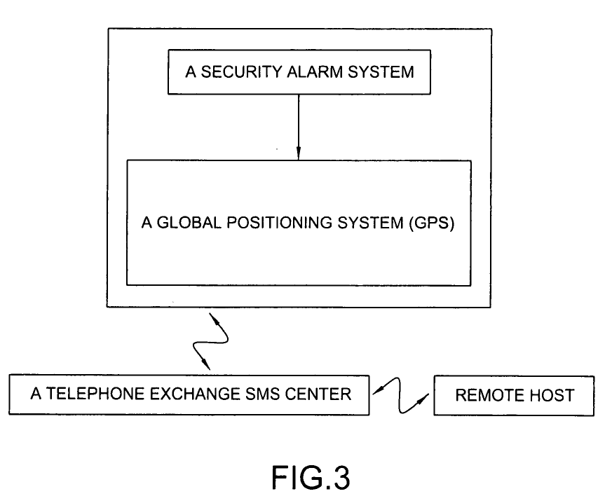

With reference to FIG. 1 and FIG. 3, the preferred embodiment of the present invention mainly depends on the GPS satellite signal-receiver module 11 of the GPS 10 to transmit signals of abnormal vehicle statuses of every checking unit together with position information via the wireless communication module 30. Then a telephone exchange SMS center 61 conveys this information to the remote host 62, so as to instantly send the vehicle status and the vehicle position to the remote host 62.

In addition, referring to FIG. 1 and FIG. 4E, the GPS satellite signal-receiver module 11 can further connect to a keypad lock 29 for setting a password. When a driver enters a vehicle, the password needs to be input with the keypad lock 29. Only when the password is correct can the GPS satellite signal-receiver module 11 cancel the checking signal processing circuit 20 or cancel the triggering mode of the external security alarm so that the vehicle can be successfully started. Otherwise, the vehicle can not be activated without authorization and an alarming message can be optionally output.

Besides, an output terminal of the GPS satellite signal-receiver module 11 can further set up a driver circuit 51 for finding the vehicle for connecting to a vehicle horn or a vehicle lamp. The owner of the vehicle can use a mobile phone to connect with the vehicle wireless communication module 30 to input a search vehicle command. After the GPS satellite signal-receiver module 11 reads the search vehicle command, the GPS satellite signal-receiver module 11 controls the driver circuit 51 instantly, so that the owner can acquire the vehicle position.

With reference to FIG. 5, to sum up, the GPS of the preferred embodiment of the present invention not only provides information concerning location of the vehicle but also sends appropriate security data such as correct password, vehicle inclination, etc to the remote host. Therefore, the present invention exactly achieves the functions of instant notification of vehicle status, greatly reduces cost of wireless remote security devices, and simplifies circuit arrangements. Furthermore, the present invention can combine with other vehicle security alarms by emulating different signal modes of the external connected security alarm, so that the present invention having high-scalability can control and receive actions of the security alarms and the checking signals.

Therefore, the present invention exactly comprises utility and conforms to novelty non-obviousness and inventive step of requirements of a patent.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A global positioning system (GPS) having an instant notification of vehicle status function comprising:
a GPS satellite signal-receiver module (11) comprising a response to vehicle status program that acquires vehicle status data detected by a checking signal processing circuit (20);
a satellite signal-receiving antenna (12) connecting with the GPS satellite signal-receiver module (11);
the checking signal processing circuit (20) connecting to the GPS satellite signal-receiver module (11) for connecting with a sensor device in a vehicle to send the vehicle status data to the GPS satellite signal-receiver module (11); and
a wireless communication module (30) connecting with the GPS satellite signal-receiver module (11), so as to set up a mutual connection of the GPS satellite signal-receiver module (11) and a remote host (62).

2. The global positioning system having the instant notification of vehicle status function as claimed in claim 1, wherein the checking signal processing circuit (20) further comprises:
a plurality of checking units for installing in appropriate positions in the vehicle to examine if there is any abnormal status of the vehicle, if the abnormal status occurs, a signal is outputted to the GPS satellite signal-receiver module (11);
a parallel input/serial output (PISO) unit (21) with an input terminal of the PISO unit (21) connecting to output terminals of each of the checking units, and an output terminal of the PISO unit (21) connecting to the GPS satellite signal-receiver module (11); and
a trigger signal unit (22) configured in the GPS satellite signal-receiver module (11) to output a signal to notify the GPS satellite signal-receiver module (11) of the abnormal status, and the GPS satellite signal-receiver module (11) reading a signal of the parallel input/serial output (PISO) unit (21).

3. The global positioning system having an instant notification of vehicle status function as claimed in claim 2, wherein the plurality of the checking units comprises:
an IGN checking unit (23), a panic checking unit (24), a crash-checking unit (25), an external cover open checking unit (26), and a satellite signal-receiving antennas short/open checking unit (27).

4. The global positioning system having the instant notification of vehicle status function as claimed in claim 1, wherein the plurality of the checking units further comprises a tilt moving checking unit (28).

5. The global positioning system having the instant notification of vehicle status function as claimed in claim 2, wherein the plurality of the checking units further comprises:
a voltage examiner unit (41) for a storage battery and a spare battery connecting with a storage battery and a spare battery separately to examine an electricity capacity; and
a circuit checking unit (42) for a storage battery supply for examining if a power supply circuit for connecting the storage battery is disconnected.

6. The global positioning system having the instant notification of vehicle status function as claimed in claim 3, wherein the plurality of the checking units further comprises:
a voltage examiner unit (41) for a storage battery and a spare battery connecting with a storage battery and a spare battery separately to examine an electricity capacity; and
a circuit checking unit (42) for a storage battery supply for examining if a power supply circuit for connecting the storage battery is disconnected.

7. The global positioning system having the instant notification of vehicle status function as claimed in claim 4, wherein the plurality of the checking units further comprises:
a voltage examiner unit (41) for a storage battery and a spare battery connecting with a storage battery and a spare battery separately to examine an electricity capacity; and
a circuit checking unit (42) for a storage battery supply for examining if a power supply circuit for connecting the storage battery is disconnected.

8. The global positioning system having the instant notification of vehicle status function as claimed in claim 1 further comprises a spare power supply circuit (40), comprising:
a recharge circuit of the spare battery (44);
a voltage examiner unit (41) for a storage battery and a spare battery between the GPS satellite signal-receiver module (11) and the storage battery and the spare battery to examine an electricity capacity of the storage battery and the spare battery, and also input to the GPS satellite signal-receiver module (11);
a circuit checking unit (42) for a storage battery supply for examining whether a power supply circuit of the storage battery is disconnected, if the power supply circuit of the storage battery is disconnected, a checking signal is outputted to a power supply switch circuit (43); and
the power supply switch circuit (43) connecting to a working power supply terminal of the wireless communication module (30), a vehicle voltage converter (45) of a storage battery connecting with the storage battery, and an output terminal of the spare battery, wherein a switch terminal is controlled by the connected circuit checking unit (42) for the storage battery supply.

9. The global positioning system (GPS) having the instant notification of vehicle status function as claimed in claim 1, wherein the GPS satellite signal-receiver module (11) further connects with an external emulation unit (50) for a security alarm signal for connecting to an external security alarm originally installed in the vehicle; wherein the external emulation unit (50) for the security alarm signal records and emulates different signal waveforms outputted by the external security alarm while actuating a security mode, temporarily canceling the security mode and triggering the security mode separately, so as to enable the GPS satellite signal-receiver module (11) to control and judge the external security alarm accordingly.

10. The global positioning system (GPS) having the instant notification of vehicle status function as claimed in claim 8, wherein the GPS satellite signal-receiver module (11) further connects with an external emulation unit (50) for a security alarm signal for connecting to an external security alarm originally installed in the vehicle; wherein the external emulation unit (50) for the security alarm signal records and emulates different signal waveforms outputted by the external security alarm while actuating a security mode, temporarily canceling the security mode and triggering the security mode separately, so as to enable the GPS satellite signal-receiver module (11) to control and judge the external security alarm accordingly.

11. The global positioning system having the instant notification of vehicle status instant notification of vehicle status function as claimed in claim 1, wherein the wireless communication module (30) is a GSM communication module.

12. The global positioning system having the instant notification of vehicle status function as claimed in claim 9, wherein the GPS satellite signal-receiver module (11) further connects with a keypad lock (29) having a built-in default password for users to input the correct password to temporarily cancel the security mode.

13. The global positioning system having the instant notification of vehicle status function as claimed in claim 10, wherein the GPS satellite signal-receiver module (11) further connects with a keypad lock (29) having a built-in default password for users to input the correct password to temporarily cancel the security mode.

14. The global positioning system having the instant notification of vehicle status function as claimed in claim 1, wherein the GPS satellite signal-receiver module (11) further connects with a driver circuit (51) for finding the vehicle for connecting to a vehicle horn or a vehicle lamp.

15. The global positioning system having the instant notification of vehicle status function as claimed in claim 12, wherein the GPS satellite signal-receiver module (11) further connects with a driver circuit (51) for finding the vehicle for connecting to a vehicle horn or a vehicle lamp.

16. The global positioning system having the instant notification of vehicle status function as claimed in claim 13, wherein the GPS satellite signal-receiver module (11) further connects with a driver circuit (51) for finding the vehicle for connecting to a vehicle horn or a vehicle lamp.

17. The global positioning system having the instant notification of vehicle status function as claimed in claim 1, wherein the response to vehicle status program writes to a memory unit (13) and the memory unit (13) is installed in the GPS satellite signal-receiver module (11).

18. The global positioning system having the instant notification of vehicle status function as claimed in claim 1, wherein the response to vehicle status program writes to a memory unit (13) and the memory unit (13) is installed external the GPS satellite signal-receiver module (11).
